(19) United States
(12) Patent Application Publication
(10) Pub. No.: US 2026/0046804 A1
(43) Pub. Date: Feb. 12, 2026

(54) METHODS, ARCHITECTURES, APPARATUSES AND SYSTEMS FOR SIGNALING REDUCTION FOR DUALSTEER DEVICES

(71) Applicant: InterDigital Patent Holdings, Inc., Wilmington, DE (US)

(72) Inventors: Taimoor Abbas, Sainte-Julie (CA); Anuj Sethi, Ottawa (CA); Rocco Di Girolamo, Laval (CA); Xavier De Foy, Kirkland (CA); Magurawalage Chathura Madhusanka Sarathchandra, London (GB); Guanzhou Wang, Brossard (CA)

(21) Appl. No.: 18/798,657

(22) Filed: Aug. 8, 2024

(51) Int. Cl. H04W 60/04; H04W 8/20; H04W 84/04

(52) U.S. Cl. CPC H04W 60/04; H04W 8/20; H04W 84/042

(57) ABSTRACT

Methods and systems are provided for user equipment (UE) of a wireless transmit/receive unit.. A first UE transmits, to a wireless network, a registration update comprising a DualSteer identifier, a first subscription permanent identifier (SUPI) associated with the first UE, a second SUPI associated with a second UE, and a signaling reduction for DualSteer indication. The first UE receives, from the wireless network, a registration accept message comprising at least one first tracking area indicator (TAI) for the first UE and at least one second TAI for the second UE and sends, to the second UE, the at least one second TAI, where the first UE and the second UE are located within a wireless transmit/receive unit. In some embodiments, a secondary UE obtains, from a primary UE, network information associated with the primary UE and transmits, to a wireless network, a registration update comprising the network information.

### TECHNICAL FIELD

The present disclosure is generally directed to the fields of communications, software and encoding, including, for example, to methods, architectures, apparatuses, systems related to signaling reduction for DualSteer Devices.

### SUMMARY

This disclosure relates to signaling reduction in DualSteer devices. DualSteer devices may have two User Equipment (UEs). In accordance with the disclosure, a DualSteer device may indicate its capability for signaling reduction to a network. Upon receiving this indication, the network may enable reduced signaling of the two UEs in the DualSteer device, thus reducing or optimizing signaling load on the secondary UE.

In certain representative embodiments, a method performed by a first user equipment (UE) is provided. The method may comprise: transmitting, to a wireless network, a registration update comprising a DualSteer identifier, a first subscription permanent identifier (SUPI) associated with the first UE, a second SUPI associated with a second UE, and a signaling reduction for DualSteer (SRD) indication; receiving, from the wireless network, a registration accept message comprising at least one first tracking area indicator (TAI) for the first UE and at least one second TAI for the second UE; sending, to the second UE, the at least one second TAI; and wherein the first UE and the second UE are located within a wireless transmit/receive unit (WTRU).

In certain representative embodiments, a method performed by a secondary user equipment (UE) is provided. The method may comprise obtaining, from a primary UE, network information associated with the primary UE; transmitting, to a wireless network, a registration update comprising a DualSteer identification, a subscription permanent identifier (SUPI) associated with the secondary UE, the network information associated with the primary UE, and a signaling reduction for DualSteer (SRD) indication; receiving, from the wireless network, a registration accept message comprising at least one tracking area indicator (TAI) for the secondary UE; and wherein the secondary UE and the primary UE are located within a wireless transmit/receive unit (WTRU).

In certain representative embodiments, a wireless transmit/receive unit (WTRU) is provided. The WTRU may comprise a first user equipment (UE); a second UE. wherein the first UE may be configured to: transmit, to a wireless network, a registration update comprising a DualSteer identifier, a first subscription permanent identifier (SUPI) associated with the first UE, a second SUPI associated with the second UE, and a signaling reduction for DualSteer (SRD) indication; receive, from the wireless network, a registration accept message comprising at least one first tracking area indicator (TAI) for the first UE and at least one second TAI for the second UE; and send, to the second UE, the at least one second TAI.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates a non-roaming dual steering architecture according to one or more embodiments;

FIG. 3 illustrates a Dual steering architecture with roaming in one access according to one or more embodiments;

FIG. 4 illustrates a Dual steering architecture with roaming in both accesses with common VPLMN according to one or more embodiments;

FIG. 5 illustrates Dual steering architecture with roaming in both accesses with two different VPLMNs according to one or more embodiments;

FIG. 6 illustrates an exemplary system according to one or more embodiments;

FIG. 7 illustrates a procedure for a DualSteer device according to one or more embodiments;

FIG. 8 illustrates a method for using user equipment to perform a registration update according to one or more embodiments; and

FIG. 9 illustrates a method for using secondary user equipment to perform a registration update according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

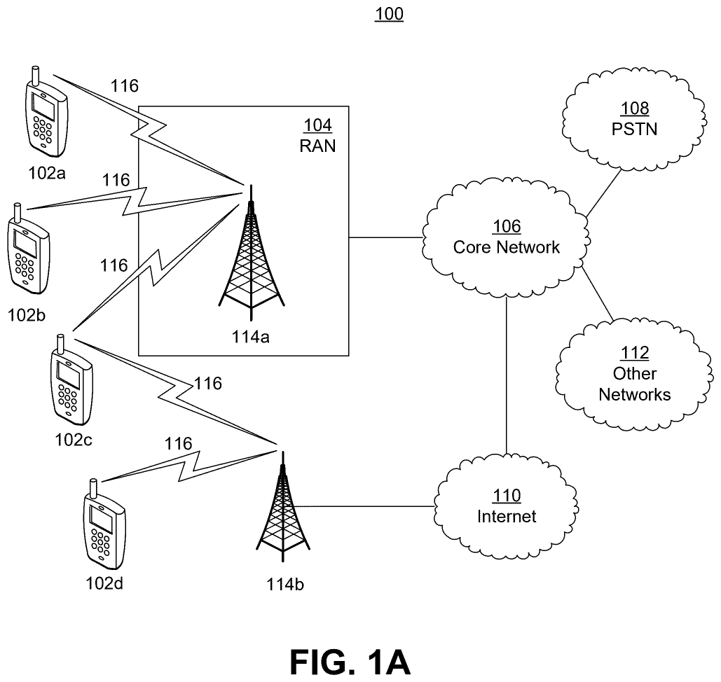

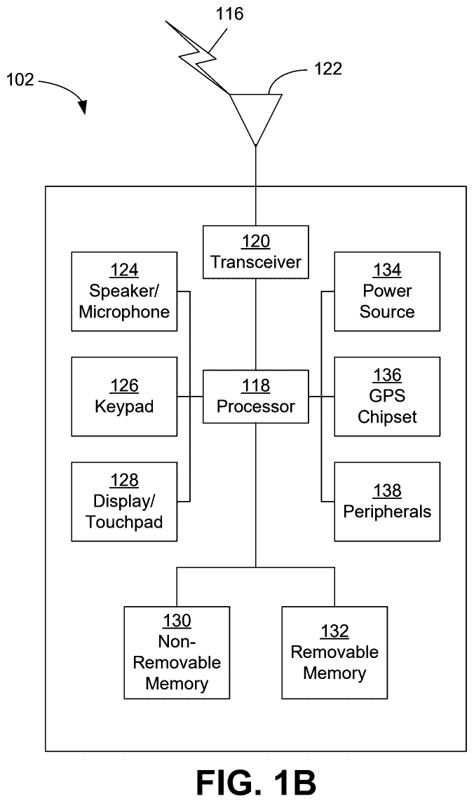

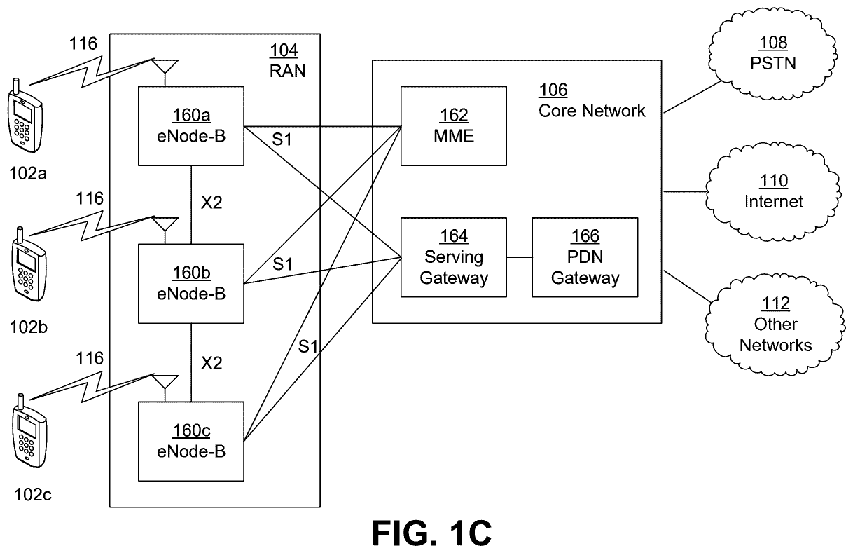

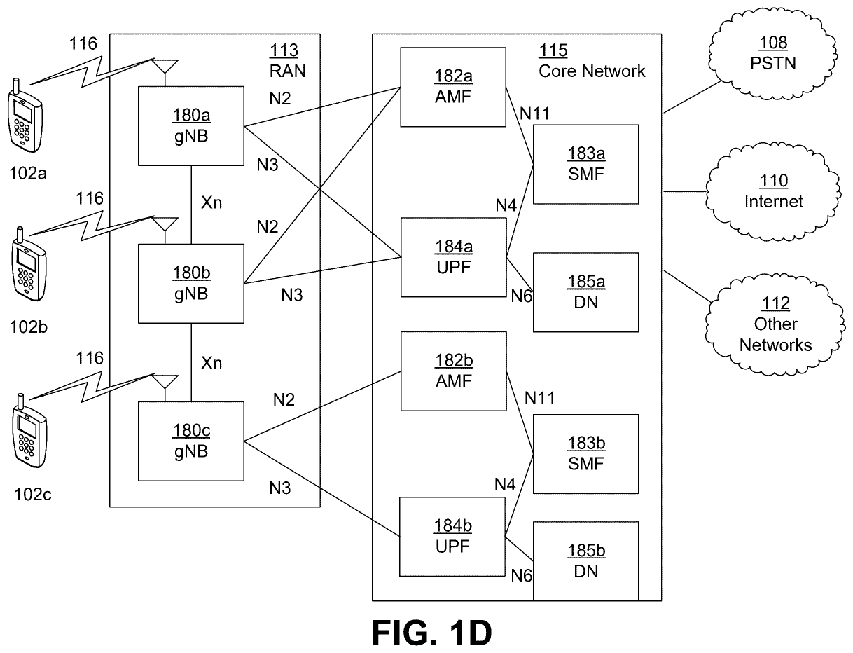

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and/or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Session and Mobility Management

In certain representative embodiments, UEs may provide both their Session Management (SM) and Mobility Management (MM) capability to the core network. A UE shall send the UE MM Core Network Capability information to the Access and Mobility management Function (AMF) during the Initial Registration procedure and Mobility Registration Update procedure, within a Non-Access Stratum (NAS) message. Similarly, a UE may include its 5GSM Core Network Capability in PDU Session Establishment/Modification Requests. These latter messages may include the UE's Access Traffic Steering, Switching and Splitting (ATSSS) capabilities.

In certain representative embodiments, UEs may perform registration to a network if they need to access services requiring registration. In order to perform this registration, the UE may need to perform a series of steps:
Public Land Mobile Network (PLMN) selection or Standalone Non-Public Network (SNPN) selection—procedure by which a UE may select a mobile network. This network may be a public network or a non-public network. The UE may follow rules to determine how to select from the available networks at a given location, and to determine when to look for higher priority networks.
Cell selection/reselection—procedure by which UE “camps” on a cell.
Registration—procedure to inform network about the UE presence and provide some coarse location information and capability exchange and negotiations.

### Splitting Traffic Across Two 3GPP Access Legs

In certain representative embodiments, carrier aggregation may be provided over a single 3GPP access (for example New Radio (NR) or Long Term Evolution (LTE)) but allows the UE to receive over two or more cells. The cells may be each on a different frequency carrier. The use of the two cells may be managed entirely in the Radio Access Networks (RAN).

In certain representative embodiments, UEs also support Dual Connectivity (DC). DC allows a UE to receive/transmit over two 3GPP accesses (or 3GPP access legs). The accesses may be NR (gNB) or LTE (eNB). In certain representative embodiments, in 5G, the deployments may have one leg over LTE and a second leg over NR. In certain representative embodiments, deployments of DC may also support two legs over NR. In this case, the two legs may be on different bands (e.g., FR1 and FR2). In order to employ DC, a UE may need the Radio Frequency (RF) front end to support both accesses. In dual connectivity, one leg may be the master leg (and part of a Master Cell Group (MCG)), and the other leg may be the secondary leg (and part of a Secondary Cell Group (SCG))

In certain representative embodiments, for the Public Land Mobile Network PLMN plus PLMN/Non-Public Network (NPN) examples, the two networks may be managed by the same operator or by different operators (assumed to have a business agreement among them).

### Traffic Steering and Switching Over Two 3GPP Access Networks

In certain representative embodiments, 3GPP may support mechanisms that enable traffic steering, switching and splitting between a 3GPP access network (e.g., Evolved Universal Terrestrial Radio Access E-UTRA or NR) and a non-3GPP access network (e.g., WiFi) since 4G. In certain representative embodiments, a mechanism may be ATSSS feature. In certain representative embodiments, new mechanisms to support traffic steering and switching over two 3GPP access networks are provided.

In certain representative embodiments, a DualSteer Device may support traffic steering and switching of user data (for different services) across two 3GPP access networks; it may be be (a) a single UE, in case of non-simultaneous data transmission over the two networks, or (b) two separate UEs in case of simultaneous data transmission over the two networks. The subscriber of the DualSteer Device may have two subscriptions/SUPIs, sharing one subscription profile from the same operator. For any particular service, at any given time, the DualSteer Device may transmit all traffic of that service using only a single 3GPP access network. A DualSteer device may be the WTRU 102 of FIG. 1B that has DualSteer capabilities.

In certain representative embodiments, there is provided various scenarios of two 3GPP access types (e.g., NR, Non-Terrestrial NR, E-UTRA) and the network types (e.g., Home-Public Land Mobile Network (H-PLMN), Visited-Public Land Mobile Network (V-PLMN), Public Network Integrated-Non-Public Network (PNI-NPN)) that the 3GPP access networks may be connected to.

In certain representative embodiments, requirements for supporting DualSteer may be at least one of the following:
A “DualSteer device” may use two SUPIs from the same operator for accessing two separate 3GPP access networks. And each SUPI may be used to connect to only one of the 3GPP access networks at any given time.
A “DualSteer device” may send its user data over two 3GPP access networks belong to the same PLMN, either non-simultaneously or simultaneously.
A “DualSteer device” may send its user data over two 3GPP access networks belong to two different PLMNs, either non-simultaneously or simultaneously.
In case of non-simultaneous data transmission over two networks, a “DualSteer device” may be a single UE. In case of simultaneous data transmission, a “DualSteer device” may be “two separate UEs”.

In case of simultaneous data transmission, the data over two separate networks may belong to different services (or different Service Data Flows).

At any given point of time, all traffic of a single service may be sent over a single access network, i.e., no service data splitting.

### UE Identities

In certain representative embodiments, the Subscription Permanent Identifier (SUPI) may be a 5G globally unique identifier allocated to each subscriber. The SUPI value may be provisioned in Universal Subscriber Identity Module (USIM) and UDM/UDR function in 5G Core. The SUPI may be either an International Mobile Subscriber Identifier (IMSI) or a Network Access Identifier (NAI). For the IMSI version of the SUPI, the first three digits represent the Mobile Country Code (MCC), the next two or three represent the Mobile Network Code (MNC) identifying the network operator or PLMN. The remainder may represent the Mobile Subscriber identification number (MSIN).

In certain representative embodiments, Subscription Concealed Identifier (SUCI) is a privacy preserving identifier containing the concealed SUPI. The SUCI may include the PLMN ID of the home network (in MCC and MNC). The MCC/MNC may be transmitted in plain text.

In certain representative embodiments, the 5G GUTI (Globally Unique Temporary Identifier) may be allocated by the AMF (Access and Mobility Management Function). The AMF may assign a new 5G-GUTI to the UE at any time. The 5G-GUTI comprises a GUAMI (Globally Unique AMF ID) and a 5G-TMSI (Temporary Mobile Subscriber Identity), where GUAMI identifies the assigned AMF and 5G-TMSI identifies the UE uniquely within the AMF. The GUAMI may be a concatenation of the PLMN ID and the AMF identifier.

### MUSIM Operation

In certain representative embodiments, a UE may have multiple USIMs that may be in operation at the same time, where each USIM allows the UE to obtain service from a different mobile network. A typical use case for MUSIM devices may be for professionals who needed a business number and a separate personal number. Instead of carrying two phones, these professionals may use a single phone with two USIM cards.

In certain representative embodiments, the terminal behavior with respect to the simultaneous handling of multiple USIMs may depend on the UE capabilities (e.g. UE with single Rx/single Tx vs UE with dual Rx/single Tx vs UE with dual Rx/dual Tx), wherein dual Rx may allows a MUSIM UE to simultaneously receive traffic from two networks, single RX allows MUSIM UE to receive traffic from one network at one time, and single Tx allows MUSIM UE to transmit traffic to one network at one time.

In certain representative embodiments, the two USIMs may run independently of each other. Each USIM may need that the UE have a dedicated Non-Access Stratum and Access Stratum protocol stacks. However, depending on the capabilities of the UE, some coordination may be needed to allow the UE to obtain service to both mobile networks. In certain representative embodiments, this coordination may not rely on mobile network interactions. As a result, the UE acts like a mediator between the two mobile networks.

In certain representative embodiments, subscriptions may be designated to two network operators through a MUSIM device as a “dual subscription”, while each distinct subscription is designated to a network operator, not involving a MUSIM device, as a “single subscription”.

### Inter-PLMN Mobility

In certain representative embodiments, a AMF may use the N14 interface for AMF re-allocation and AMF to AMF information transfer. This interface may be either intra-PLMN or inter-PLMN (e.g., in the case of inter-PLMN mobility).

At inter PLMN mobility, the source AMF may select an AMF instance(s) in the target PLMN by querying target PLMN level NRF via the source PLMN level NRF with target PLMN ID. The target PLMN level NRF may return an AMF instance address based on the target operator configuration. After the Handover procedure the AMF may select a different AMF.

### DualSteer Device Architecture

In certain representative embodiments, a DualSteer architecture may be based on providing a common anchor (UPF) and session management function (SMF) inside the 5GC for the DS traffic from both 3GPP access networks.

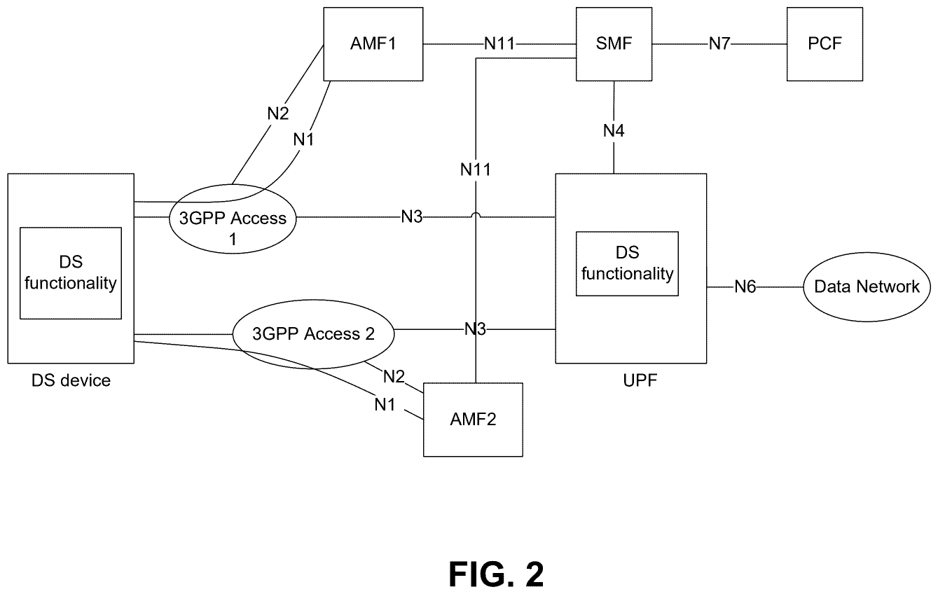

FIG. 2 illustrates a non-roaming dual steering architecture according to one or more embodiment. This architecture may allow a user equipment (UE) with DualSteer capability to connect to two separate 3GPP access networks simultaneously. The UE establishes PDU sessions, each associated with a different access network. Two separate Access and Mobility Management Functions (AMFs) manage the mobility and session context for the UE on their respective networks. A single Session Management Function (SMF) controls the overall PDU sessions and traffic steering for the UE across both access networks. User plane data is anchored at a User Plane Function (UPF), which routes traffic between the data network and the UE through one or both access networks as directed by the SMF.

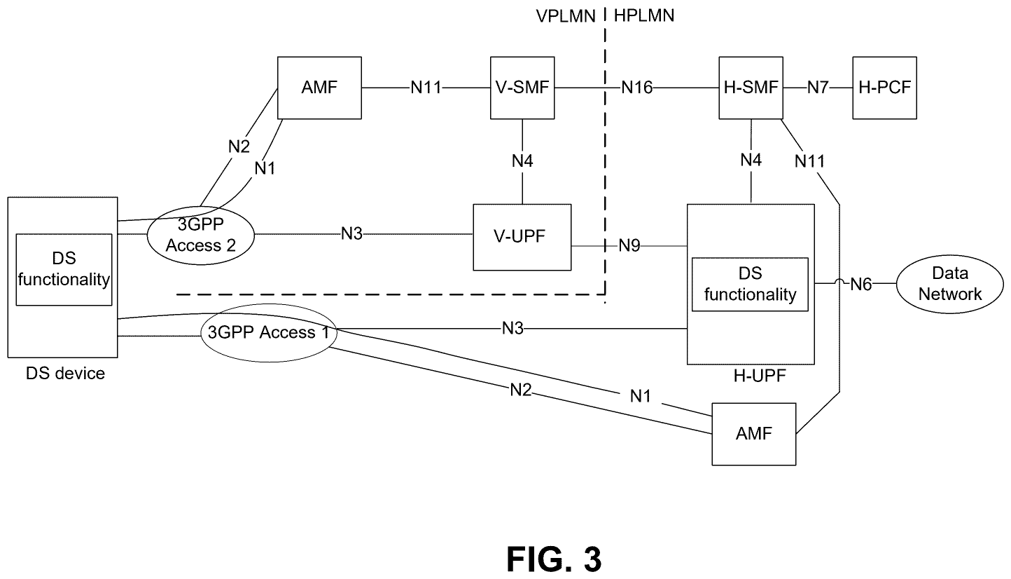

FIG. 3 illustrates a Dual steering architecture with roaming in one access according to one or more embodiment. A user equipment (UE) with DualSteer functionality establishes connections with two distinct networks: the home public land mobile network (HPLMN) through 3GPP Access 1 and a visited public land mobile network (VPLMN) through 3GPP Access 2.

In the VPLMN, the UE connects to a first AMF. User plane data is anchored at two UPFs: the V-UPF in the VPLMN and the H-UPF in the HPLMN. Traffic is routed between the UE and the data network through either or both UPFs as directed by the SMFs.

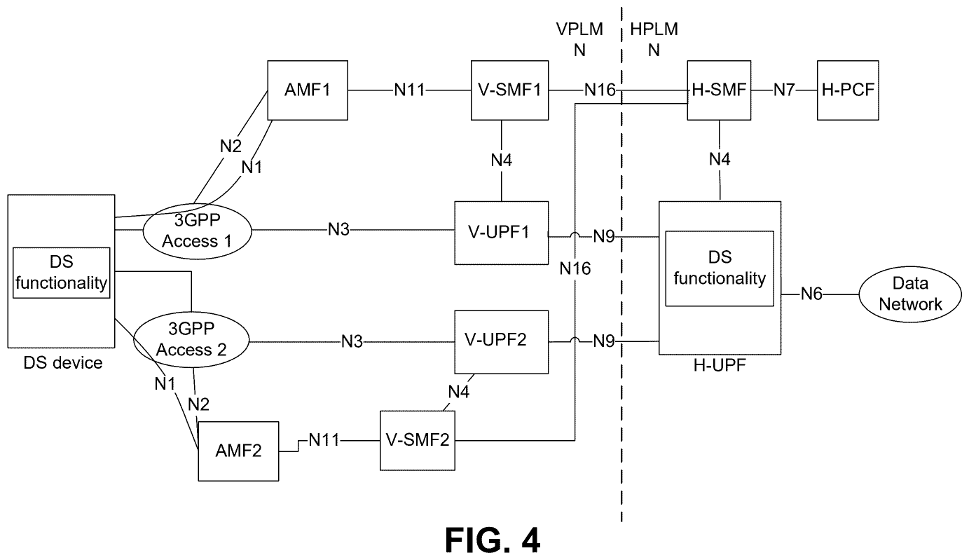

FIG. 4 illustrates a Dual steering architecture with roaming in both accesses with common VPLMN according to one or more embodiment. A user equipment (UE) with DualSteer functionality establishes connections with two distinct 3GPP access networks (3GPP Access 1 and 3GPP Access 2) in the same VPLMN. Two separate AMFs manage the mobility and session context for the UE on their respective access networks (AMF1 for 3GPP Access 1, AMF2 for 3GPP Access 2). User plane data is anchored at two V-UPFs (V-UPF1 and V-UPF2) located in the VPLMN and one H-UPF located in the HPLMN. Traffic is routed between the UE and the data network through any of these UPFs as directed by the SMFs.

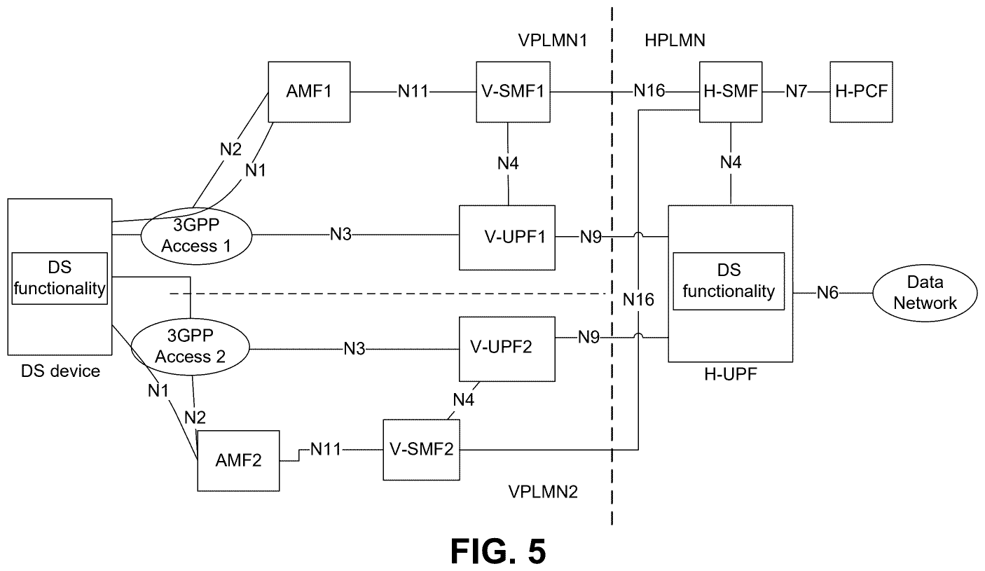

FIG. 5 illustrates Dual steering architecture with roaming in both accesses with two different VPLMNs according to one or more embodiment. A UE establishes connections with two distinct 3GPP access networks (3GPP Access 1 in VPLMN1 and 3GPP Access 2 in VPLMN2).

Each VPLMN has its dedicated Access and Mobility Management Function (AMF) and Session Management Function (V-SMF), responsible for managing UE's mobility and session context in their respective networks. Traffic flows between the UE and the Data Network through either V-UPF or H-UPF as directed by the SMFs.

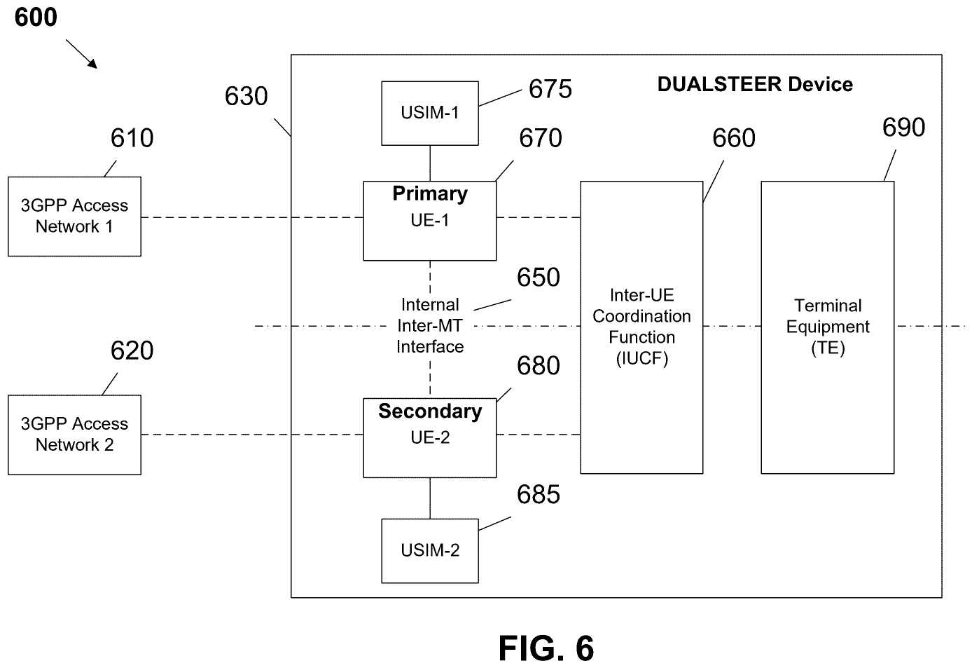

FIG. 6 illustrates an exemplary system 600 according to one or more embodiments. The system 600 may include a DualSteer device 630. The DualSteer device 630 may be the WTRU 102 of FIG. 1B that has DualSteer capabilities. In certain representative embodiments, a UE may have two separate UEs and USIMs. For example, each UE may provide one or more functionalities of a UE (e.g., at least one of radio transmission, radio reception, baseband signal processing, access to USIM, access to CP stack, access to UP stack, combinations of the same, or the like). A common Terminal Equipment (TE) may be provided (as shown, for example, in FIG. 6). In certain representative embodiments, two separate TEs corresponding to two UEs may be provided. An internal inter-UE interface between two UEs may be provided. The internal inter-UE interface may be configured to allow two UEs to exchange information. In certain representative embodiments, two UEs may exchange information through a higher layer “Inter-UE Coordination Function (IUCF)”. Two UEs may be identified by two unique device identifiers such as IMEIs. An additional ID called DualSteer specific UE ID (DS-specific-UE-ID) may be used to interlink the Primary and Secondary UE in a DualSteer device.

In certain representative embodiments, as illustrated in the example of FIG. 6, a system 600 is provided. The system 600 may include a DualSteer device 630 configured to communicate with a first 3GPP access network 610 and/or a second 3GPP access network 620. The DualSteer device 630 may include a first or primary UE 670 and a second or secondary UE 680. The first or primary UE 670 and the second or secondary UE 680 may communicate, e.g., via an internal inter-UE interface 650. The first or primary UE 670 may have a first USIM 675 . The second or secondary UE 680 may have a second USIM 685.

For example, an Inter-UE Coordination Function (IUCF) 660 may be provided. The IUCF 660 may be provided in the higher layer. The IUCF 660 may be part of a TE 690. The communication between UEs or between the UE and the IUCF 660 may use AT commands. Two UEs may be identified by two unique device identifiers such as International Mobile Equipment Identities (IMEIs).

Both UEs may have a separate subscription for registering to mobile network. Primary UE may Register to a PLMN at first, and the Secondary UE 680 may Register only when it is triggered by the Primary UE directly or via the IUCF layer 260. A UE in a DualSteer capable WTRU may include the Information of primary or secondary UE as part of its Registration Request message and send it to the network.

In certain representative embodiments, signaling reduction for DualSteer devices is provided. The signaling reduction may be enabled by indicating signaling reduction (SRD) capability using SRD indication. An SRD indication may be provided by the DualSteer devices to the network, e.g., upon registration. If the network supports SRD for DualSteer devices, then upon reception of SRD indication it may enable the coordinated and/or synchronized control plane signaling between the two UEs to reduce or optimize the signaling for the secondary UE in a DualSteer device. In certain representative embodiments, the SRD capability may be part of the device subscription information associated with the device. This capability may be stored in a Unified Data Management (UDM) and retrieved during registration procedure or PDU session establishment.

### Signaling Reduction in Registration procedure for DualSteer (DS) Device

In certain representative embodiments, a UE may performs at least one of the following steps: 1) Primary/Secondary UE/DualSteer UE may support signaling reduction for dual steer; 2) to indicate that Signaling Reduction for DualSteer (SRD) may be supported SRD bit is set, which may either be enabled by the DualSteer device (Primary or the secondary UE) or by the network; 3) a PLMN may support SRD or not, and for DualSteer device case it may depend on the serving PLMNs of the two UEs, e.g., PLMN 1 may support SRD with PLMN 2 but not with PLMN 3, if the secondary UE registers to PLMN2, it may provide information about PLMN1 together with SRD indication. An AMF2 may check its configuration and may determine if SRD is supported with PLMN1. The AMF2 may reply with an SRD indication ack, which is used by the UE to determine if SRD will be used or not; 4) if the network support SRD, it may allocate Tracking Area Identity (TAI) list depending upon the situation, i.e., same TAI list for both, or TAI list for Primary UE+TAI List Secondary UE; 5) the secondary network may inform the secondary NG-RAN (Next Generation Radio Access Network) about the mobility information (TAI list) as provided to the UE in the previous step; 6) Mobile Network Operator (MNO) may inform the primary UE registered Network about activation of SRD, primary network may update TAI list and may provide both TAI list to the primary UE, for example TAI list may be TAI list primary UE+TAI list secondary UE, and MNO may inform the primary NG-RAN as well with the mobility information (TAI List), for example TAI list for the primary and secondary may be the same; 7) in certain representative embodiments, step 5 can be skipped and DualSteer UE may update the TAI list for both primary and secondary UE internally, based on SRD activated indication from the network and secondary network would coordinate with the primary network to update respective NG-RANs; 8) SRD may be monitored via a periodic timer on UE and/or on the Network side, at expiry of this timer—the UE may need to trigger registration procedure to continue with the SRD; 9) in certain representative embodiments, Primary UE while registering may request support for SRD, if NW does not support it, it may trigger PLMN selection to find alternate PLMN which supports SRD; 10) in certain representative embodiments, SRD request from the secondary UE may trigger a different behavior; 11) in certain representative embodiments, if energy saving is enabled for the Secondary UE, then it may receive TAI list set to “all PLMN”, and after registering it may go into Mobility via IP Connectivity Optimization (MICO) kind of mode. It may be in deep sleep and only when required may wake up based on the trigger from the Primary UE. This may go with the use case that secondary UE might act as a backup for the primary UE; 12) in certain representative embodiments, for the downlink traffic, which is directed for the secondary UE, the secondary UE may be informed via the Primary UE by Notification/Paging/DL NAS Transport or other NAS signaling messages, the Primary UE may internally inform the secondary UE, which may respond back to the network.

In certain representative embodiments, a DualSteer Device may support traffic steering and switching of user data (for different services) across two 3GPP access networks. A DualSteer device may send its user data over two 3GPP access networks belonging to the same PLMN or different PMLN, either simultaneously or non-simultaneously.

In certain representative embodiments, a DualSteer device may have two separate UEs or mobile terminals (MTs) with individual USIM (two SUPIs), with each MT providing functionalities that are in a MT of a traditional UE, such as radio transmission/reception, baseband signal processing, access to USIM, CP/UP stacks, etc. These two separate MTs may be termed as Primary and Secondary MT within the DualSteer device (Dual-MT Capable device). Primary and secondary UE may have different capabilities, e.g., the primary UE may act like a normal UE whereas the secondary UE may have limited capabilities.

In certain representative embodiments, two USIMs in a DualSteer device may be co-located and there may be an association between the 2 SUPIs for the DualSteer device, e.g., DS-specific-UE-ID. The two UEs may be either in the same DualSteer device or maybe a few meters apart but in the same geographical location and linked as they belong to the same DualSteer device. Both UEs may camp to the same PLMN or to the two different PLMNs. For mobility registration update or periodic registration update both may require registration update, e.g. if the registration area changes, or if the timer has expired. If the registration update due to mobility or periodic timer may be performed for both UE, it may increase signaling overhead. in certain representative embodiments, both UEs may not always be active, both may not have simultaneous traffic, e.g., when one UE is the primary and the other is only for the back-up to switch traffic. In such scenarios uncoordinated or unsynchronized registration update for both UEs may be a waste of resources. Reduction on signaling, exploiting the fact that the two UEs are in the same DualSteer device may greatly impact the performance.

In certain representative embodiments, the control plane signaling for a DualSteer device may be optimized for different procedures.

In certain representative embodiments, different procedures may include, e.g., registration and mobility management, service request and UE configuration update.

In certain representative embodiments, a DualSteer capable device with two UEs where one of the two is designated as a Primary UE and the other as a Secondary UE is provided. Designation of a primary UE and a secondary UE may be permanent, or dynamic based on the steering modes. One of the UEs, e.g., primary UE, may have full capability (for example it may behave as a standard cell phone), while the other UE, e.g., secondary UE, may have limited capability.

In certain representative embodiments, a common identifier called DualSteer specific UE ID, e.g., DS-specific-UE-ID, Common PDU session ID or similar, may be used to interlink the Primary and Secondary UEs at initial registration or PDU session establishment to network and to associate their PDU sessions. The DualSteer specific UE ID i.e. DS-specific-UE-ID may derived at the Inter-UE coordination function (IUCF) layer based on the application, or service being used and provided to the UEs, configured by a NF (e.g. AMF, PCF) during Mobility Registration procedure, in either of the Primary/Secondary UE and exchanges internally, Pre-configured in the DualSteer capable devices, Provided by application in the UE or application server over the application layer (user plane).

In certain representative embodiments, a DualSteer device may have only Primary UE registered to the network, and a secondary UE registration is triggered based on internal trigger, for example., when a PDU session establishment for the secondary UE is desired so that traffic needs to be switched from primary to the secondary. In certain representative embodiments, both UEs may have registered to the network but only Primary UE may be active, and the secondary UE may be idle and waits for a trigger from the Primary UE. It may also be possible that both UEs perform simultaneous registration. In either of the above cases both of the UEs may use the common ID, e.g., DS-specific-UE-ID, so the network can identify that the UEs are linked to the same device.

In certain representative embodiments, a method of signaling reduction for DualSteer devices is provide. The signaling reduction may be enabled by indicating signaling reduction (SRD) capability using SRD indication. An SRD indication may be provided by the DualSteer devices to the network, e.g., upon registration. If the network supports SRD for DualSteer devices, then upon reception of SRD indication it may enable the coordinated and/or synchronized control plane signaling between the two UEs to reduce or optimize the signaling for the secondary UE in a DualSteer device. Alternatively, the SRD capability may be part of the device subscription information associated with the device. This capability may be stored in a Unified Data Management (UDM) and retrieved during registration procedure or PDU session establishment.

In certain representative embodiments, a UE in a DualSteer device that is SRD capable may send an SRD indication to the PLMN upon initial registration, at mobility or periodic registration update, service request, PDU session establishment or via other NAS control plane signaling procedures.

In certain representative embodiments, a PLMN may support SRD or not, and for DualSteer device case it may depend on the serving PLMNs of the two UEs, e.g., PLMN 1 may support SRD with PLMN 2 but not with PLMN 3. If the secondary UE registers to PLMN2, it may provide information about PLMN1 together with SRD indication. AMF2 may check its configuration and may determine if SRD is supported with PLMN1. AMF2 may reply with an SRD indication ack, which may be used by the UE to determine if SRD will be used or not.

In certain representative embodiments, when the primary UE registers with PLMN1 and indicates its SRD capability, AMF1 may provide a list of PLMNs that will support SRD with PLMN1. This list of PLMN may be shared with the secondary UE and may be used by the secondary UE for PLMN selection.

In certain representative embodiments, it may be assumed that the primary UE is always performing the updates for both UEs or triggers the secondary UE to perform any updates. However, in certain representative embodiments, it may be either of the two UEs based on link quality, network load, configurations or their capabilities. In certain representative embodiments, there may be a logic at the DualSteer device or at the network, to decide who is going to perform update for a given service, e.g., there may be a scenario where primary is in an active session while the secondary is idle and being dual TX/RX UE. It may be the secondary UE who gets triggered.

In certain representative embodiments, e.g. network triggered service request procedure, SRD may be triggered by the network given the network is aware of SRD capability of a DualSteer device.

### Signaling Reduction in Registration procedure for DS device

In certain representative embodiments, a UE in a DualSteer device that is SRD capable may send an SRD indication to the PLMN upon initial registration, at mobility or periodic registration update, service request, PDU session establishment or via other NAS control plane signaling procedures.

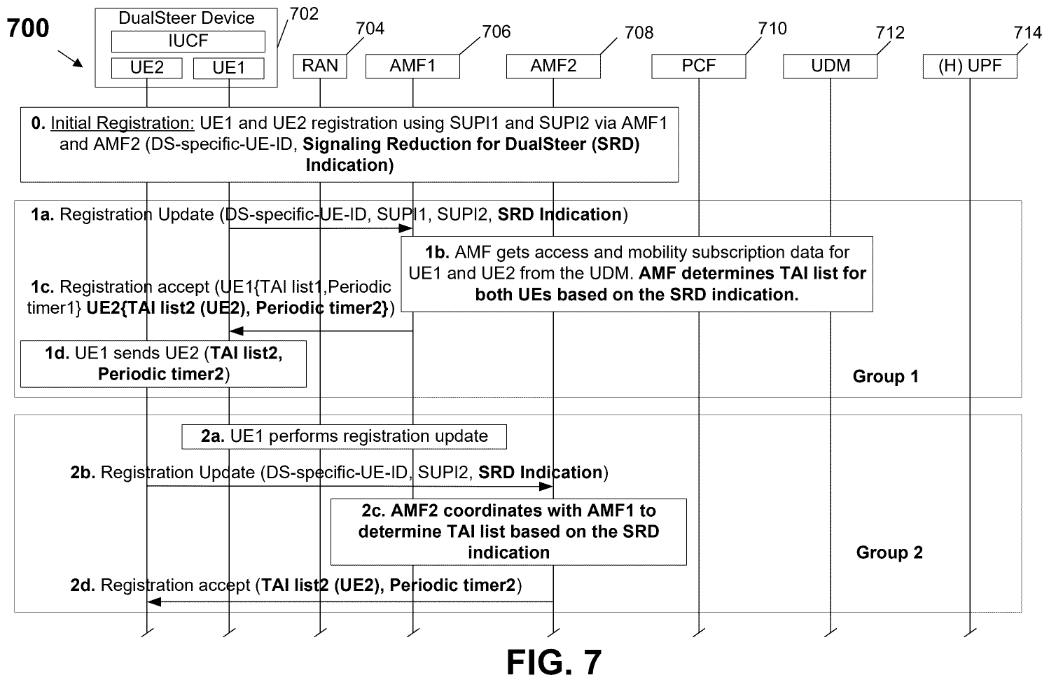

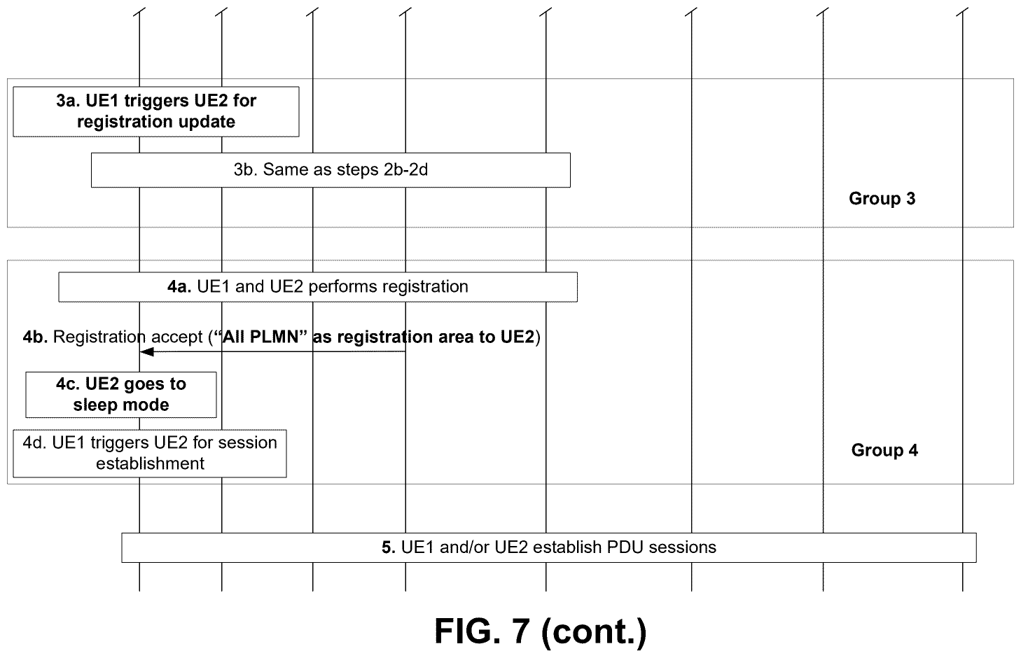

FIG. 7 illustrates a procedure 700 for a control plane signaling reduction for a DualSteer device 702 according to one or more embodiments. The DualSteer device 702 may be similar to or the same as the WTRU 102 of FIG. 1B or the DualSteer device 630 of FIG. 6. The procedure 700 may be enabled by indicating signaling reduction (SRD) capability using SRD indication at the initial registration or registration update.

The DualSteer device 702 may comprise a first UE (UE1), a second UE (UE2) and an Inter-UE Coordination Function (IUCF). The first UE may be primary UE and the second UE may be secondary UE. The UEs within the DualSteer device 702 may be configured with SUPI for each USIM, and DualSteer specific configurations. The inter-UE coordination function (IUCF) in the DualSteer device 702 may be used for the coordination and communication between the two UEs, where one is Primary MT/UE and other is Secondary MT/UE.

In certain representative embodiments, a primary UE may register with the network as normal, while the signaling reduction is applicable to a secondary UE.

The procedure 700 may include step 0. At step 0, the UE1 and UE2 may perform initial registration with PLMN1 and PLMN2 using SUPI1 and SUPI2 via an AMF1 706 and AMF2 708, respectively. In certain representative embodiments, both UEs may register to the same PLMN, i.e., PLMN1=PLMN2, and if it is the same PLMN it is also possible that the AMF1 706=AMF2 708. In certain representative embodiments, only one of the UEs (Primary UE) performs registration while the UE2 may be for backup and may wait for an internal trigger to initiate registration request procedure. In either of the cases above, the DualSteer device 702 that supports Signaling reduction for DualSteer (SRD) may provide SRD indication during initial registration in the registration request message. To indicate that Signaling Reduction for DualSteer (SRD) is supported SRD bit is set, which could either be enabled by the DualSteer device 702 (Primary or the secondary UE) or by the network (i.e. RAN 704). The network may comprise a PCF 710, and (H) UPF 714.

The procedure 700 may include any one of steps 1a, 1b, 1c and 1d in Group 1. In this exemplary embodiment, both UEs are registered to the same PLMN (HPLMN). The Primary UE1 may be managing the registration request or registration update for both UEs in the DualSteer device 702. The secondary UE2 may be mainly acting as a backup UE where the traffic can be steered, or switched based on the steering modes. It should be appreciated that in other exemplary embodiments, the UE1 and UE2 may be registered to different PLMNs.

The procedure 700 may include step 1a. At step 1a, the primary UE1 may perform a registration update for both UEs which may be Mobility Registration Update (i.e. the UE1 is in RM-REGISTERED state and initiates a Registration procedure due to mobility, or to request a change of the set of network slices it is allowed to use), a Periodic Registration Update (i.e. the UE1 is in RM-REGISTERED state and initiates a Registration procedure due to the Periodic Registration Update timer expiry). The registration request may include DS-specific-UE-ID, SUPI1, SUPI2 and SRD Indication.

The procedure 700 may include step 1b. At step 1b, the AMF1 706 may perform the Nudm_UECM_Registration operation, in case of mobility if the AMF1 706 has changed (handover procedure) and once Nudm_UECM_Registration operation is successful and if the AMF1 706 does not have subscription data (because UE1 is sending a new request) for both the UEs, then the AMF1 706 may retrieve the Access and Mobility Subscription data for the UE1 and UE2 using Nudm_SDM_Get from a UDM 712, the AMF1 may also indicate SDR capability to the UDM 712. The UDM 712 may provide indication that the subscription data for network slicing is updated to reduce signaling for one or both UEs given SRD capability is supported by the network. Based on the subscription information retrieved from the UDM 712, and network support for SRD the AMF1 706 may determines the TAI lists and periodic registration update timer for both UEs.

The procedure 700 may include step 1c. At step 1c, the AMF1 706 may send to the UE1 the registration accept message which may includes for UE1{TAI list1, Periodic registration timer1}, and for UE2 {TAI list2, Periodic registration timer2 (synchronized with UE1's), TAI List for S-NSSAIs allowed to be used when SRD is supported, List of equivalent PLMNs for UE2 that support SRD, List of non-equivalent PLMNs that support SRD}.

A Primary or secondary network may inform the TAI lists (for UE1 and UE2) to their respective NG-RAN so the RAN 704 may prioritize resources for the DualSteer session, based on the capabilities of the UE1 and the DualSteer session requirements for the primary and the secondary.

The procedure 700 may include step 1d. At step 1d, the UE1 may send the information to the UE2 as received in the registration accept message directly or over the IUCF layer.

In one embodiment, the parameters stated above are the same for UE1 and UE2, and the trigger for mobility registration update or periodic registration update are the same, i.e. only UE1 performs the update for both UEs and UE2 internally receive the updates from UE1, which will certainly reduce the signaling.

In certain representative embodiments, the parameters may be different for the UE1 and the UE2, and the UE2 may use them when it triggers service request procedure. The service request procedure may be moving from an idle state to a connected state/mode to establish PDU session, or moving from an unregistered state to a registered state.

The procedure 700 may include any one of steps 2a, 2b, 2c and 2d in Group 2. The steps in Group 2 may be alternative to the steps in Group 1. In an exemplary embodiment, both UEs may be registered to two different PLMNs, e.g., HPLMN1 and PLMN2. It should be appreciated that in other exemplary embodiments, UE1 and UE2 may be registered to the same PLMN. At first the UE1 may perform initial registration to HPLMN1 and indicate SRD capability of the DualSteer device 702. The UE1 may receive a list of equivalent or preferred PLMNs for the UE2 if HPLMN2 is unavailable, which may be passed to the UE2 by the UE1 internally, e.g., via IUCF. The UE2 may perform registration to the PLMN2 based on the availability, which is either the HPLMN2 or an equivalent PLMN suggested by HPLMN1. The UE2 may indicate SRD capability in registration request.

The procedure 700 may include step 2a. At step 2a, the UE1 may perform registration update as a normal UE following a registration procedure, but the UE1 may include SRD indication.

The procedure 700 may include step 2b. At step 2b, the UE2 may perform registration update and sends a registration request to its respective AMF2 708 and may include SRD indication. The UE2 may have received the PLMN1 ID and/or AMF1 ID from the UE1 which is included in the registration request (for example it may include the GUAMI for the UE1) so the AMF2 708 may use the GUAMI for the UE1 to coordinate with the AMF1 706 and determine the parameters, e.g., TAI list, and periodic registration timer.

The procedure 700 may include step 2c. At step 2c, the AMF2 708 may receive registration request from the UE2 that includes information of PLMN1 and/or the AMF1 706. the AMF2 708 may use this information to coordinate with the AMF1 706 to get TAI list, TAIRangeList values and periodic registration timer values that are allocated to the UE1 by the AMF1 706. Based on the information received from the AMF1 706, via AMF1-AMF2 interface such as N14 when served by the same PLMN or Security Edge Protection Proxy (SEPP) when roaming, the AMF2 708 may allocate a coordinated TAI list and a synchronized periodic registration timer to the UE2. Such a coordinated TAI list, and timer could reduce signaling for the UE2. For example, the UE2 may be allocated the same TAI list as the UE1, and longer expiry timer than the UE1, so the UE2 may not have to do frequent updates. The UE2 may wait for the UE1 input, and only triggers an update when TAI triggers the UE2.

The procedure 700 may include step 2d. At step 2d, the AMF2 708 may send a registration accept message to the UE2 and sends the coordinated TAI list and synchronized periodic registration timer to the UE2.

The procedure 700 may include any one of steps 3a, and 3b in Group 3. The steps of Group 3 may be performed in an embodiment similar to the Group 2, with a difference that the UE2 does not initiate the registration or registration update on its own. The UE2 may wait for a trigger from the UE1.

The procedure 700 may include step 3a. At step 3a, the UE2 may be a backup UE, where traffic may be switched from the UE1 to the UE2. In this case, the UE1 may trigger the UE2 to perform registration update or UE triggered service request, based on the certain conditions, which may be pre-configured in the UE1 or configured by the network when a DualSteer session is established for the UE1.

The procedure 700 may include step 3b. At step 3b, once the UE2 received the trigger from the UE1, the UE2 may perform any of steps 2b-2d as specified above.

The procedure 700 may include any one of steps 4a, 4b, 4c and 4d in Group 4. In an exemplary embodiment both UEs in the DualSteer device 702 may be registered to the same PLMN or two different PLMNs, but the secondary UE (the UE2) may be for backup to steer or switch traffic for seamless connection, or may be in power saving mode and be awakened by the UE1 when required.

The procedure 700 may include step 4a. At step 4a, the UE1 and UE2 may perform initial registration update following either of Groups 1-3 as stated above, but the UE2 beside SRD indication may have provided additional information. Examples of this additional information include: power saving is deployed, the UE2 is for backup to steer or switch traffic for seamless connection etc.

The procedure 700 may include step 4b. At step 4b, Based on the information received from the UE2 in Step 4a, the AMF1 706 may allocate “all PLMN” i.e., the whole PLMN, as registration area to the UE2. In this way, whenever the traffic is steered to the UE2, the UE2 may not require an updated TAI list.

The procedure 700 may include step 4c. At step 4c, the UE2 after registration accept, may enter sleep mode.

The procedure 700 may include step 4d. At step 4d, the UE2 may receive a trigger from the UE1 internally, whenever PDU session needs to be established via the UE2, otherwise the UE2 may remain idle.

The procedure 700 may include step 5. At step 5, a PDU session may be established for DualSteer for either UE or both UEs, as required.

In certain representative embodiments, the primary UE or UE1 may be the main UE, while the secondary UE or UE2 may be for backup. Therefore, the UE1 may be managing or performing the registration update. In certain representative embodiments either of the two UEs may be managing or performing the registration update based on the steering mode, link-quality, network load or other capabilities either pre-configured within the DualSteer device 702 or configured by the network. There may be a logic at the UE (DualSteer Device) or at the network, to decide who is going to perform update, e.g. there may be a scenario where primary is in an active session while the secondary is idle and being dual TX/RX UE. It may be the secondary UE who gets triggered.

In certain representative embodiments, the signaling reduction for a DualSteer device according to the above embodiments for mainly registration procedure may be further extended to other NAS control plane signaling procedures.

In certain representative embodiments, the paging procedure for a secondary UE may be done via a primary UE i.e. notification request to the primary UE from the network for the secondary UE, which will trigger the secondary UE to transition from the idle state to connected (RRC) state.

In certain representative embodiments, during the registration or subsequent procedure to reduce signaling a DS device may be configured in such a way that DL and UL signaling messages for both UEs are sent or received by only one of the UEs, e.g. SMS can be delivered via a primary UE for a secondary UE.

In certain representative embodiments, a secondary UE may be put into special mobile originated traffic only mode, which means the secondary UE may stay in idle mode until and unless the secondary UE has significant amount of mobile originated traffic coming from the upper layers (application layer). For small amount of data transport, the primary UE may be used to transport data via UL NAS transport messages.

In should be appreciated that the order and grouping of the steps above are exemplary and non-limiting and in other embodiments any of the steps may be omitted or any of the steps may be combined in any other order.

In certain representative embodiments, a method may performed by a first AMF. The method may include: receiving, by the first AMF, registration request from a first UE, including a DS-specific-UE-ID, SUPI1 associated with the first UE, SUPI2 associated with a second UE and SRD Indication. The method may include determining, by the first AMF, TAI lists and optionally periodic registration update timer for both UEs. The method may include sending, by the first AMF, to the first UE a registration accept message which may include the TAI list and optionally Periodic registration timer for both UEs.

In certain representative embodiments, a method may be performed by a first AMF. The method may include: receiving, by the first AMF, a registration request from a secondary UE that may include information of a PLMN and/or a second AMF associated with a primary UE. The method may include determining, by the first AMF, a coordinated TAI list and a synchronized periodic registration timer for the secondary UE based on the received information. The method may include, sending, by the first AMF, a registration accept message to the secondary UE that may include at least one of the coordinated TAI list and synchronized periodic registration timer for the secondary UE.

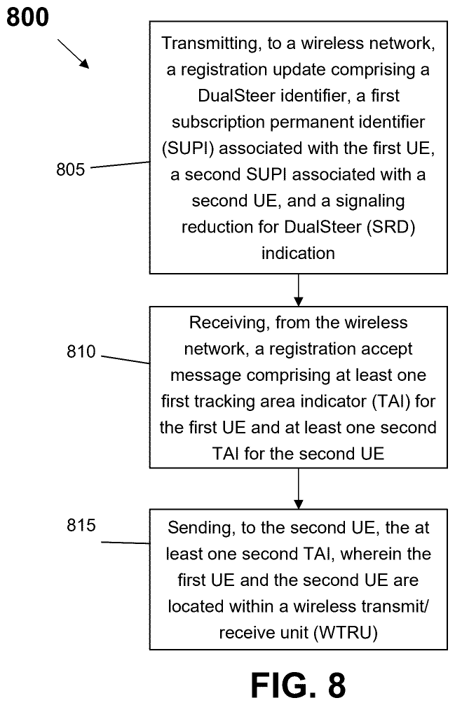

FIG. 8 illustrates a method 800 for using user equipment to perform a registration update according to one or more embodiments. The method 800 may be performed by a first user equipment (UE). The first UE may be located within a WTRU such as the WTRU 102 of FIG. 1B, the DualSteer device 630 of FIG. 6 or the DualSteer device 702 of FIG. 7. The method 800 may include the first UE transmitting 805, to a wireless network, a registration update comprising a DualSteer identifier, a first subscription permanent identifier (SUPI) associated with the first UE, a second SUPI associated with a second UE, and a signaling reduction for DualSteer (SRD) indication. In some embodiments, the transmitting 805 corresponds to step 1a of FIG. 7. The method 600 may further include the first UE receiving 810, from the wireless network, a registration accept message comprising at least one first tracking area indicator (TAI) for the first UE and at least one second TAI for the second UE. In some embodiments, the receiving 810 corresponds to step 1c in FIG. 7. The method 800 may further include the first UE sending 815, to the second UE, the at least one second TAI, wherein the first UE and the second UE are located within a wireless transmit/receive unit (WTRU). In some embodiments, the sending 815 corresponds to such step 1d of FIG. 7.

In some implementations, the at least one second TAI may comprise an entire public land mobile network (PLMN) area.

In some implementations, the method 800 may further include the first UE providing a trigger to the second UE for a session establishment. In some embodiments, the trigger is provided as shown in step 4d of FIG. 7.

In some implementations, the first UE and the second UE may be registered to the same PLMN.

In some implementations, the first UE may be associated with a first Universal Subscriber Identity Module (USIM), the second UE may be associated with a second USIM; and the first UE and the second UE may be registered to different PLMNs.

In some implementations, the at least one second TAI may be sent to the second UE through an inter-UE coordination function layer. In some implementations, the at least one second TAI may be directly sent to the second UE from the first UE.

In some implementations, the method 800 may further include the first UE receiving, from the wireless network, a first periodic registration timer for the first UE and a second periodic registration timer for the second UE, such as shown in step 1c of FIG. 7 and sending the second periodic registration timer to the second UE, such as shown in step 1d of FIG. 7.

In some implementations, the method 800 may further include the first UE receiving a trigger to initiate a service request procedure for the second UE and sending the trigger to the second UE.

In some implementations, the SRD indication may comprise information indicative of a coordination capability between the first UE and the second UE to the wireless network.

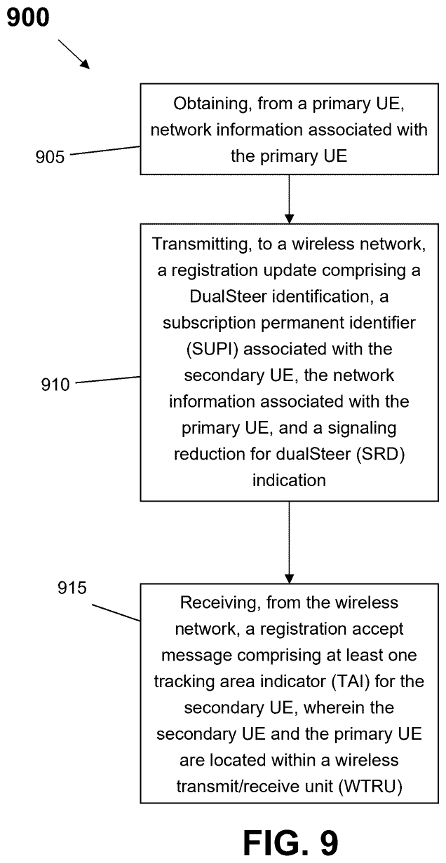

FIG. 9 illustrates a method 900 for using secondary user equipment to perform a registration update according to one or more embodiments. The secondary UE may be located within a WTRU such as the WTRU 102 of FIG. 1B, the DualSteer device 630 of FIG. 6 or the DualSteer device 702 of FIG. 7. The method 900 may include the secondary UE obtaining 905, from a primary UE, network information associated with the primary UE. The method 900 may further include the secondary UE transmitting 910, to a wireless network, a registration update comprising a DualSteer identification, a subscription permanent identifier (SUPI) associated with the secondary UE, the network information associated with the primary UE, and a signaling reduction for DualSteer (SRD) indication. In some embodiments, the transmitting 910 corresponds to step 2b of FIG. 7. The method 900 may further include the secondary UE receiving 915, from the wireless network, a registration accept message comprising at least one tracking area indicator (TAI) for the secondary UE, in some embodiments, the receiving 91 corresponds to step 2d of FIG. 7, where the secondary UE and the primary UE are located within a wireless transmit/receive unit (WTRU).

In some implementations, the at least one TAI comprises an entire public land mobile network (PLMN) area.

In some implementations, the method 900 may further include the secondary UE transitioning to a sleep state (e.g., as shown in step 4c of FIG. 7) and receiving, from the primary UE, a trigger to transition to a connected state for a session establishment (e.g., as shown in step 4d of FIG. 7).

In some implementations, the primary UE and the secondary UE may be registered to different PLMNs.

In some implementations, the method 900 may further include the secondary UE receiving, from the primary UE, a trigger for registration update (e.g., as shown in step 3a of FIG. 7.)

In some implementations, the method 900 may further include the secondary UE receiving, from the wireless network, a periodic registration timer (e.g., as shown in step 2d of FIG. 7), where the periodic registration timer indicates a period longer than a period indicated by a periodic registration timer associated with the primary UE.

In some implementations, the method 900 may include the secondary UE obtaining the network information associated with the primary UE through an inter-UE coordination function layer.

In some implementations, the network information associated with the primary UE may comprise an identification of a PLMN associated with the primary UE and/or an identification of an access and mobility management function (AMF) associated with the primary UE.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S. C.§ 112, ¶ 6 or means-plus-function claim format, and any claim without the terms “means for” is not so intended.

What is claimed is:

1. A method performed by a first user equipment (UE), the method comprising:
transmitting, to a wireless network, a registration update comprising a DualSteer identifier, a first subscription permanent identifier (SUPI) associated with the first UE, a second SUPI associated with a second UE, and a signaling reduction for DualSteer (SRD) indication;
receiving, from the wireless network, a registration accept message comprising at least one first tracking area indicator (TAI) for the first UE and at least one second TAI for the second UE;
sending, to the second UE, the at least one second TAI; and
wherein the first UE and the second UE are located within a wireless transmit/receive unit (WTRU).

2. The method of claim 1, wherein the at least one second TAI comprises an entire public land mobile network (PLMN) area.

3. The method of claim 2, further comprising:
providing a trigger to the second UE for a session establishment.

4. The method of claim 1, wherein the first UE and the second UE are registered to the same PLMN.

5. The method of claim 1, wherein the first UE is associated with a first Universal Subscriber Identity Module (USIM),
the second UE is associated with a second USIM; and
the first UE and the second UE are registered to different PLMNs.

6. The method of claim 1, wherein the at least one second TAI is sent to the second UE through an inter-UE coordination function layer.

7. The method of claim 1, further comprising:
receiving, from the wireless network, a first periodic registration timer for the first UE and a second periodic registration timer for the second UE; and
sending the second periodic registration timer to the second UE.

8. The method of claim 1, further comprising:
receiving, from the wireless network, a trigger to initiate a service request procedure for the second UE; and
sending the trigger to the second UE.

9. The method of claim 1, wherein the SRD indication comprises information indicative of a coordination capability between the first UE and the second UE to the wireless network.

10. A method performed by a secondary user equipment (UE), the method comprising:
obtaining, from a primary UE, network information associated with the primary UE;
transmitting, to a wireless network, a registration update comprising a DualSteer identification, a subscription permanent identifier (SUPI) associated with the secondary UE, the network information associated with the primary UE, and a signaling reduction for DualSteer (SRD) indication;
receiving, from the wireless network, a registration accept message comprising at least one tracking area indicator (TAI) for the secondary UE; and
wherein the secondary UE and the primary UE are located within a wireless transmit/receive unit (WTRU).

11. The method of claim 10, wherein the at least one TAI comprises an entire public land mobile network (PLMN) area.

12. The method of claim 11, further comprising:
transitioning to a sleep state; and
receiving, from the primary UE, a trigger to transition to a connected state for a session establishment.

13. The method of claim 10, wherein the primary UE and the secondary UE are registered to different PLMNs.

14. The method of claim 10, further comprising:
receiving, from the primary UE, a trigger for registration update.

15. The method of claim 10, further comprising:
receiving, from the wireless network, a periodic registration timer, wherein the periodic registration timer indicates a period longer than a period indicated by a periodic registration timer associated with the primary UE.

16. The method of claim 10, wherein the network information associated with the primary UE is obtained through an inter-UE coordination function layer.

17. The method of claim 10, wherein the network information associated with the primary UE comprises an identification of a PLMN associated with the primary UE and/or an identification of an access and mobility management function (AMF) associated with the primary UE.

18. A wireless transmit/receive unit (WTRU) comprising:
a first user equipment (UE);
a second UE; and
wherein the first UE is configured to:
transmit, to a wireless network, a registration update comprising a DualSteer identifier, a first subscription permanent identifier (SUPI) associated with the first UE, a second SUPI associated with the second UE, and a signaling reduction for DualSteer (SRD) indication;
receive, from the wireless network, a registration accept message comprising at least one first tracking area indicator (TAI) for the first UE and at least one second TAI for the second UE; and
send, to the second UE, the at least one second TAI.

19. The WTRU of claim 18, wherein the at least one second TAI comprises an entire public land mobile network (PLMN) area.

20. The WTRU of claim 18, wherein the first UE is further configured to:
provide a trigger to the second UE for a session establishment.
